(19) United States
(12) Patent Application Publication
(10) Pub. No.: US 2023/0109092 A1
(43) Pub. Date: Apr. 6, 2023

(54) System and Method for Synthesizing Carbon Nanotubes and Hybrid Materials Via Catalytic Chemical Deposition

(71) Applicant: Chasm Advanced Materials, Inc., Canton, MA (US)

(72) Inventors: Ricardo A. Prada Silvy, Norman, OK (US); David J. Arthur, Canton, MA (US)

(21) Appl. No.: 17/954,899

(22) Filed: Sep. 28, 2022

Related U.S. Application Data
(60) Provisional application No. 63/251,334, filed on Oct. 1, 2021.

(51) Int. Cl. C01B 32/162

(52) U.S. Cl. CPC C01B 32/162; C01B 2202/34; C01B 2202/36

(57) ABSTRACT

A reactor system and a related method that are configured to produce carbon-containing material by exposure of carbon-containing reaction gas to catalyst particles. The reactor system includes a reactor that contains a heated reaction volume wherein the reaction gas is exposed to the catalyst particles, at least one reaction gas entry port into the reaction volume, and at least one catalyst particle entry into the reaction volume. The catalyst particles are heated before they contact the reaction gas.

### CROSS-REFERENCE TO RELATED APPLICATION

This application claims priority of U.S. Provisional Application 63/251,334 filed on Oct. 1, 2021.

### BACKGROUND

This disclosure relates to the synthesis of carbon nanotubes and related hybrid materials.

The chemical and energy industries are facing new technological challenges to significantly reduce the levels of gas emissions in the atmosphere which contribute to global warming of the planet. New processes and catalytic reactors are being developed to maximize the use of each molecule of carbon and hydrogen without producing CO₂ emissions. Companies that produce different types of carbon (carbon nanotubes, carbon black, synthetic graphite, activated carbon, etc.) from catalytic or thermal processes using methane, ethylene, propylene, acetylene, carbon monoxide and other carbon sources, generate significant volumes of CO₂ through the combustion of these unreacted molecules or solid waste during the process. Hence the importance of developing new processes, catalysts and more efficient reactors that allow for increases in the selectivity and yield of the product and the better use of the reaction gases, avoiding their subsequent burning to produce CO₂ and significantly reducing the product production costs.

There are several commercial processes for the production of carbon nanotubes. The most commonly used is the Catalytic Chemical Vapor Deposition (CCVD) process/method due to its better control of the distribution of chiralities in the synthesis of single walled carbon nanotubes (SWCNT), leading to product consistency in morphological properties, and scalability in the production of multi-walled carbon nanotubes (MWCNT). The CCVD method used in the large-scale production of carbon nanotubes employs fluidized bed reactors or rotary tube (also known as rotary kiln) reactors. Each of these reactors has advantages and disadvantages. For example, fluidized bed reactors allow better heat and mass transfer between the reaction gas and the catalyst, which can produce a more precisely controlled nanotube product structure. The catalytic reaction is also more efficient. The disadvantage is that it is difficult to use catalysts in fine powder form due to particle entrainment and fluidization challenges. Rotary tube reactors can easily operate in continuous mode with catalysts in fine powder form but have the limitation of lower quality of contact between the reaction gas and the catalyst. These limitations can be improved by an optimized rotary tube reactor design.

### SUMMARY

The present disclosure includes an optimized reactor design and a system, process, and method for the production of carbon nanotubes (CNT) and also CNT hybrid materials. The reactants are arranged to come into contact at or close to the desired reaction temperature. This improves both the yield and quality of the CNT and CNT hybrid materials. In some examples the particulates (the catalyst and any other solid materials) and the reaction gas(es) are pre-heated to the reaction temperature before they come into contact in the reactor. At least the catalyst feed includes means to protect the catalyst in an inert environment until it contacts the reaction gas.

In some examples a rotary tube catalytic reactor is used. In some examples the catalyst is fed to the reactor through an internal tube under a flow of an inert gas (e.g., N₂, He, Ar), which allows the solid particles to come into contact with the gaseous carbon source (ethylene, acetylene, methane, ethane, carbon monoxide, etc.) at the same temperature as the catalytic reaction takes place. Under these conditions, a higher carbon nanotube yield is achieved, and the CNT have higher aspect ratio (long tubes of smaller diameter) compared to the reactor design of the prior art. To improve the gas and solid contact quality during the reaction, flyers or other particle distribution structures can be placed inside the rotary tube. In some examples the residence time of the reactants in the reactor is controlled. In some examples the volume of the solid reactants is about 15% to about 30% of the reactor volume, or more generally up to about 30% of the reactor volume.

Another aspect of the process design is the use of an H₂-carbon source separation membrane at the outlet of the reactor. The separation allows the carbon source to be recycled, leading to better efficiency and utilization of more of the carbon molecules that enter the process. This makes the process environmentally friendly in terms of lower or no CO₂ emissions, and a better use of hydrogen for other industrial uses, for instance; in other chemical processes that require H₂ or for the production of heat or electrical energy. The reactor design also allows the use of unsupported metallic catalysts, which provides greater flexibility in the production of different carbon nanomaterials.

The present invention differs from and is advantageous over the prior art at least as follows:

The way the catalyst is fed into the reactor to ensure that the catalyst particles are at the same temperature as the carbon source in the gas phase.

The recycling of unreacted gas, which makes the process more economically profitable, and also avoids emissions of gases that contribute to the greenhouse effect.

Use of a hydrogen membrane for the selective separation of the carbon source and the H₂ produced during the reaction.

The use of hydrogen produced in other processes, or as a source of heat, power generation and for use in vehicle transportation, for example.

Flexibility for using supported or un-supported active metals catalysts for the synthesis of different carbon nanomaterials.

The inclusion of other solid particulate material(s) to produce CNT hybrid materials. CNT hybrid materials in both carpet and mesh forms are disclosed in U.S. patent application Ser. No. 17/515,520, filed on Oct. 31, 2021, and U.S. patent application Ser. No. 17/667,373, filed on Feb. 8, 2022. The entire disclosures of these two applications are incorporated herein by reference, for all purposes.

Pre-blending of other solid particulate materials and the catalyst.

Bringing both the catalyst and the gaseous carbon source to the desired reaction temperature before the two are contacted.

In cases where the other particles are endothermic or exothermic the particles can be pre-conditioned as desired. For examples particles can be dried or heated so they don't release moisture in the reaction zone or don't release unwanted reactants in the reaction zone. Such pre-conditioning can in some examples be accomplished with a second rotary kiln reactor that is upstream of the reactor.

In some examples the reactor is configured to be easy to clean before reaction runs, both in terms of physical cleanout and burnout following each run.

All examples and features mentioned below can be combined in any technically possible way.

In one aspect, a reactor system that is configured to produce carbon-containing material by exposure of carbon-containing reaction gas to catalyst particles includes a reactor that contains a heated reaction volume wherein the reaction gas is exposed to the catalyst particles, at least one reaction gas entry port into the reaction volume, and at least one catalyst particle entry into the reaction volume. In the system and method, the catalyst particles are heated before they contact the reaction gas.

Some examples include one of the above and/or below features, or any combination thereof. In an example the carbon-containing material comprises at least one of carbon nanotube-containing material, carbon nanotube-hybrid material, and carbon nanotubes. In an example the carbon nanotube-hybrid material comprises at least one of carbon nanotubes-carbon black, carbon nanotubes-graphite, carbon nanotubes—graphene nano-platelets, carbon nanotubes—silicon, carbon nanotubes—alumina, carbon nanotubes—magnesium oxide, carbon nanotubes—silica, carbon nanotubes—activated carbon, carbon nanotubes—cementitious material, carbon nanotubes—SiOₓ, and carbon nanotubes—carbon fiber materials.

Some examples include one of the above and/or below features, or any combination thereof. In an example the catalyst particle entry comprises a duct that passes from outside the reactor into the reaction volume. In an example the reactor comprises a rotary tube reactor. In an example the reaction volume is heated to a reaction temperature. In an example the catalyst particles are heated to approximately the reaction temperature before they contact the reaction gas. In an example the reactor comprises an outlet for the carbon-containing material that is produced in the reactor, unreacted reaction gas, and reaction by-products. In an example the system further comprises a gas/solid separator that is fluidly coupled to the reactor outlet and is configured to separate the carbon-containing material from the unreacted reaction gas and reaction by-products. During the purging of air from the vessel containing the catalyst, or of the reactant gases (e.g., ethylene and hydrogen) from the reactor, the flow of inert gas can entrain fine particles of catalyst or product. These particles should be trapped before escaping into the atmosphere. Accordingly, in one example the reactor system comprises particulate filters located in the purge system of the catalyst and product containers and in the gas outlet lines of the reactor. In an example the system further comprises a gas/liquid separator vessel that is fluidly coupled to the gas outlet and is configured to separate by condensation polymerized carbon compounds produced by thermal decomposition of the carbon source from the unreacted reaction gas and reaction by-products. In an example the reactor system further comprises a gas recycling system that is configured to return at least some of the unreacted reaction gas to the reactor. In an example the reactor system further comprises a gas separator that is configured to separate unreacted reaction gas from reaction by-products. In one example, the reactor system comprises several gas samplings ports used for the analysis of its composition by mass spectrometry or other analytical techniques. These gas sampling ports can be located at the inlet and outlet of the reactor and in the recycle system. In an example the reaction by-products comprise hydrogen. In an example the reactor system further comprises a product vessel that is configured to hold carbon-containing material separated by the gas/solid separator. In an example the product vessel is flushed with inert gas. The process gas can be fed into the reactor in a co-current or counter-current direction to the catalyst feed.

Some examples include one of the above and/or below features, or any combination thereof. In an example the catalyst particle entry comprises a catalyst feed tube that passes from outside the reactor into the reaction volume. In an example the catalyst feed tube extends along from about ⅙ to about ⅓ of a length of the reactor. In an example the reactor has a diameter, and the catalyst feed tube has a diameter of about ⅓ to about ½ the diameter of the reaction volume. In an example the reactor system further comprises a catalyst feed system that is configured to feed catalyst into the feed tube and out of the feed tube into the reactor. In an example the catalyst feed system comprises a vibratory feeder that is configured to move catalyst along and out of the feed tube at a controllable rate. In an example the catalyst feed system further comprises a catalyst holding vessel that is flushed with inert gas and is configured to supply catalyst to the vibratory feeder. In an example the catalyst feed system further comprises a screw feeder that is configured to supply catalyst to the holding vessel at a controllable rate. In an example the catalyst feed system further comprises a screw feeder supply vessel that is flushed with inert gas and is configured to supply catalyst to the screw feeder. In an example the temperature in the reaction volume is measured through a thermowell. In an example the catalyst feed tube has an outlet located in the reaction volume, and the thermowell is located proximate the catalyst feed tube outlet.

Some examples include one of the above and/or below features, or any combination thereof. In an example the reaction volume is heated to at least about 400° C. In an example the reaction volume and the catalyst are heated to at least about 400° C. In an example the reaction volume and the catalyst are heated to at least about 650° C. In an example a residence time of catalyst in the reactor is at least 6 minutes. In an example hydrogen composition in the reaction gas is up to about 30%.

Some examples include one of the above and/or below features, or any combination thereof. In an example the carbon-containing material comprises carbon nanotubes (CNT). In an example the CNT have a length of at least about 7 microns. In an example the CNT have a length to diameter ratio of at least about 500. In an example the CNT comprise one or more of multi-wall, double-wall, and single-wall CNT. In an example the reaction volume and the catalyst are heated to at least 700° C. when ethylene is the carbon source. In an example the reaction volume and the catalyst are heated to at least 950° C. when methane is the carbon source.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 is a schematic representation of an exemplary rotary tube reactor design and CNT production process of the present invention.

FIG. 2 illustrates carbon yield at different reaction temperatures.

FIG. 3 illustrates an influence of the hydrogen composition in the reaction gas on the carbon yield.

FIG. 4 includes SEM images of the multi-wall CNT (MWCNT) from experiment 1.

FIG. 5 includes SEM images of the MWCNT from experiment 6.

### DETAILED DESCRIPTION

Examples of the systems, methods and apparatuses discussed herein are not limited in application to the details of construction and the arrangement of components set forth in the following description or illustrated in the accompanying drawings. The systems, methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the computer program products, systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

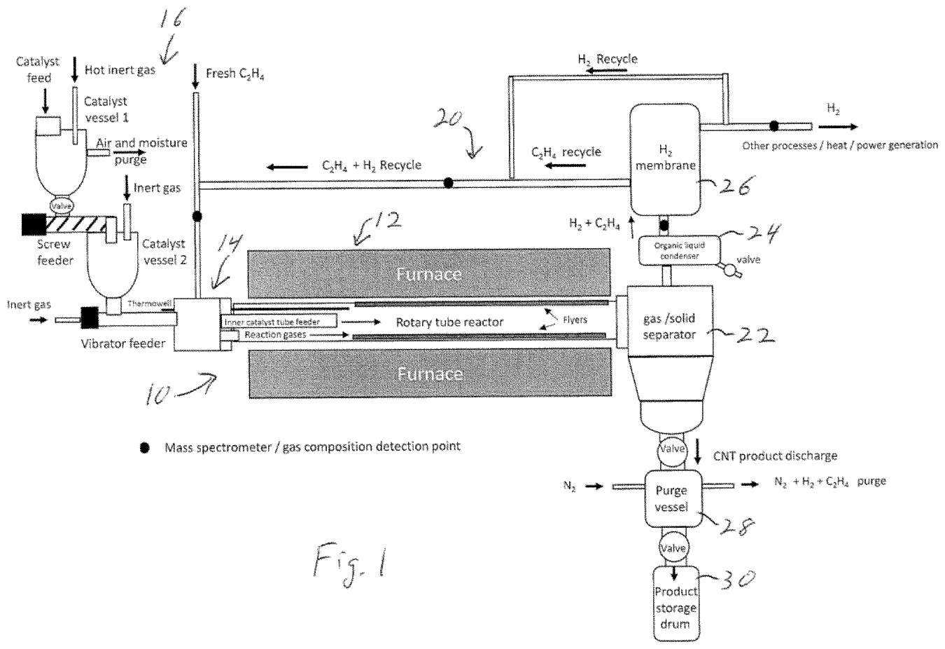

FIG. 1 is a schematic representation of an exemplary rotary tube reactor system 10 that is configured to be used to accomplish the CNT/CNT hybrid production processes of the present disclosure. The following description illustrates certain aspects of the disclosure but is not limiting of the scope of the disclosure.

A catalyst feed system 16 can operate as follows. Catalyst particles in powder form are fed into the catalyst supply accumulation vessel 1. The air is subsequently removed from the catalyst supply accumulation vessel 1 using a flow of an inert gas. The inert gas can be preheated at temperatures between 60-150° C. to remove moisture from the catalyst during the purging process. The catalyst particles are then transferred to the second catalyst supply accumulation vessel 2 through a screw feeder. This equipment controls the amount of catalyst fed to the reactor 12. The catalyst and reaction gas feed system 14 can operate as follows. The catalyst particles contained in the second catalyst supply accumulation vessel are fed to the rotary tube reactor through a metal tube coupled to a vibrating catalyst particle feed system. The supply system is maintained in an inert gas atmosphere to inhibit unwanted reactions. When other material(s) are added along with the catalyst in order to produce CNT hybrid materials, these other material(s) can be fed together with the catalyst, or there can be a separate, parallel feed system for the other material(s). The second feed system can be the same as the catalyst feed system, or otherwise configured to bring these material(s) to reaction temperature before they are fed into the reactor. In some examples the catalyst and other material(s) are pre-blended before being fed together into the reactor in the manner described above for the catalyst feed.

The tube that feeds catalyst/other materials into the reactor is long enough such that its end is located inside the rotary tube in the preheating zone of the furnace. In some examples the length of the inner tube is approximately ⅓ to ⅙ of the length of the rotary tube in the hot (reaction) zone of the furnace. In some examples the diameter of the inner tube is between ⅓ to ½ the diameter of the rotary tube. In some examples there are multiple heating zones of the reactor. In some examples the reactor is heated by gas or by electricity.

This arrangement results in the catalyst particles reaching the desired reaction temperature before coming into contact with the reaction gases. The inner tube is made of a special corrosion resistant steel, such as Inconel, titanium, etc. The length and diameter of the inner tube relative to the rotary tube is selected to ensure efficient heat transfer during the catalytic process.

The temperature of the process gas and the catalyst particles in the place where they enter in intimate contact is measured through a thermocouple introduced into a thermowell located in the inlet block of the reactor, indicated by a solid black line. Depending on the type of material to be synthesized, flyers or other mass-distribution structures (indicated schematically in FIG. 1) can be placed in the rotating tube to improve the transfer of mass and heat between the solid particles and the reaction gas. Flyers can also improve material flow within the rotating tube. The residence time of the catalyst within the reactor is controlled through the tube rotation speed and its inclination angle.

The product obtained is separated from the gas at the outlet of the reactor, for example using gas/solid separator 22. A system of valves discharges the product into containers (e.g., purge vessel 28) that have an inert gas injection to remove ethylene and hydrogen and cool the material before being packaged (e.g., in storage drum 30).

Liquid condenser 24 is used to remove undesired reaction by-products before hydrogen separation and recycling of reaction gases.

Unreacted ethylene (or other carbon-source reaction gas) and hydrogen are subsequently separated using a H₂ membrane separator 26 that may comprise: organic polymers, nano-porous inorganic materials (ceramic, oxides, porous vycor glass, etc.), dense metal (Pd, and metal alloys), carbon and carbon-nanotubes based membranes, etc.

Unreacted carbon source is then recycled by recycle system 20, and the hydrogen can be used for other catalytic industrial processes, or for other purposes such as for power or heat generation or for transportation. The recycled gas can contain ethylene and hydrogen which facilitates the production reaction of carbon nanotubes and hybrid materials through improved heat transfer and catalyst activation. The amount of fresh ethylene to be fed to the reactor will depend on the level of ethylene conversion in the production of carbon nanotubes/hybrid materials.

The gas composition can be detected at several points as indicated in FIG. 1, using a mass spectrometer or other instrument. The composition data can be used for process control and for other purposes, such as for recording gas composition and quality. A controller (not shown in FIG. 1) is input with the gas composition data (and other variables) and controls valves, heaters, particle feeders and other process equipment (not all shown in FIG. 1) that is used to maintain desired process conditions.

The following detailed description of examples illustrates but does not limit the scope of the present disclosure.

### Example 1: Effect of the Gas-Catalyst Contact Temperature and Residence Time on the Carbon Nanotube Yield

A FeCoMo/MgO-Al₂O₃ catalyst prepared according to the prior art (R. Prada Silvy, Y. Tan, U.S. Pat. No. 9,855,551) was employed to demonstrate differences between the prior art vs. the present invention. A series of experiments were conducted where the effect of the contact temperature between the catalyst and the reaction gas (C₂H₄ 60% V, H₂ 10% V and N₂ 30% V) and the residence time (min) in the rotating tube were investigated (results found in Table 1).

Experiments 1 to 4 consisted of contacting the catalyst with the reaction gas at different temperatures (150, 300 and 500° C.) and then the oven was rapidly heated until reaching the reaction temperature (650° C.). In experiments 1, 3, and 4 the material residence time in the rotary tube reactor was 10 minutes whereas for experiment 2 the residence time was 16 minutes. In experiments 5 and 6, that represent the current invention, the catalyst was preheated under a flow of N₂ until it reached the reaction temperature (650° C.), and it was then contacted with the reaction gas at 6- and 10-min residence time, respectively.

The residence time of the material within the reactor is a parameter that determines the productivity of the process. Similar results in carbon yield (i.e., the percentage of carbon in the product) are observed when the results obtained in experiments 2, 3 and 5 are compared. It can be clearly seen that the catalyst preheated to the reaction temperature presents the same percentage of carbon at a shorter residence time (6 min) than in the prior art (10 and 16-min, respectively). The highest carbon yield is obtained when the catalyst is preheated to 650° C. and the residence time is 10 minutes.

TABLE 1
Effect of the gas-catalyst contact temperature and residence
time on the carbon nanotube yield.

| | Contact temperature (° C.) | Residence time | Carbon Yield |
|---|---|---|---|
| Experiment | (Catalyst + C₂H₄ + H₂) | (min) | (wt %) |
| 1- | 150 → 650 | 10 | 63 |
| 2- | 150 → 650 | 16 | 74 |
| 3- | 300 → 650 | 10 | 75 |
| 4- | 500 → 650 | 10 | 76 |
| 5- | 650 (this invention) | 6 | 73 |
| 6- | 650 (this invention) | 10 | 79 |

### Example 2: Reactivity of the Catalysts at Different Temperatures

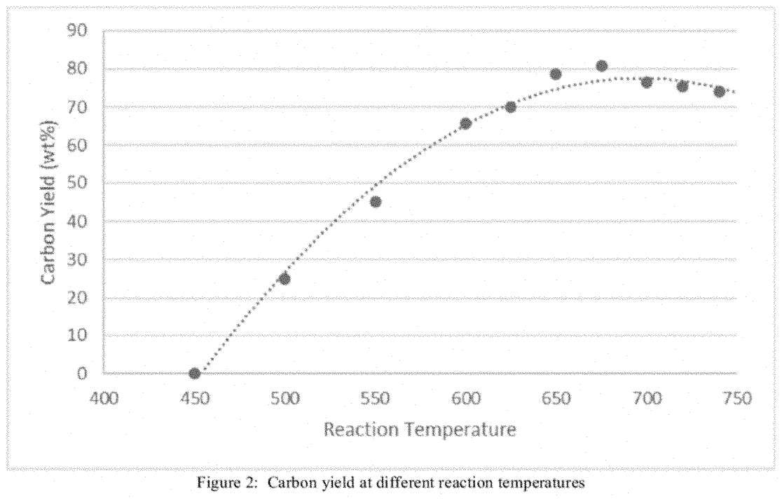

In another set of experiments, the effect of reaction temperature was investigated. In this case, the catalyst was contacted with the reaction gas at different temperatures (300-750° C. range) for 10 minutes residence time. The results are shown in FIG. 2. No reaction was observed between the catalyst and the carbon source for T≤450° C. The carbon yield increases progressively with increasing reaction temperature until reaching a plateau at T≥675° C. Signs of catalyst deactivation were observed at T≥700° C. When catalyst deactivation occurs, carbon yield decreases, and the diameter of the tube increases due to the sintering of the active metal aggregates.

### Example 3

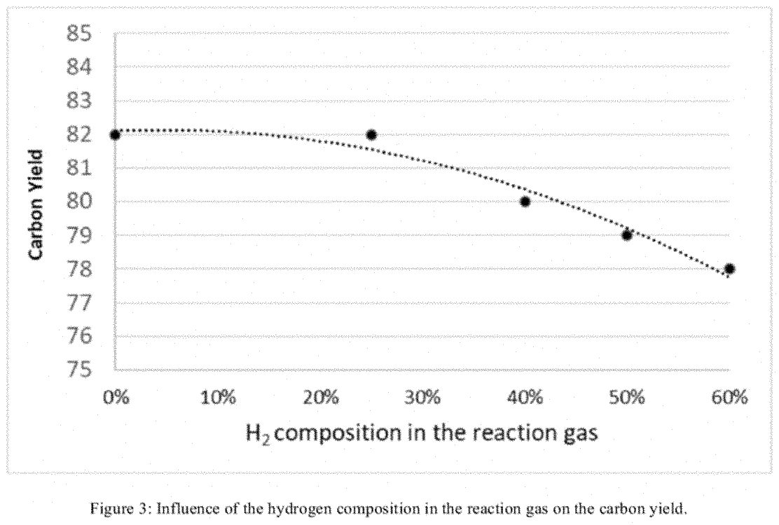

Another series of experiments run at 675° C. were carried out to investigate how the H₂ composition in the reaction gas affects the carbon yield. These results help to establish the desired maximum H₂ composition in the recycle gas. FIG. 3 shows that the carbon yield remains constant up to a percentage of H₂ of about 30% V and then begins to progressively decrease to higher percentages in the reaction mixture.

### Example 4: Properties of the CNTs Synthesized in Prior Art Vs Present Invention

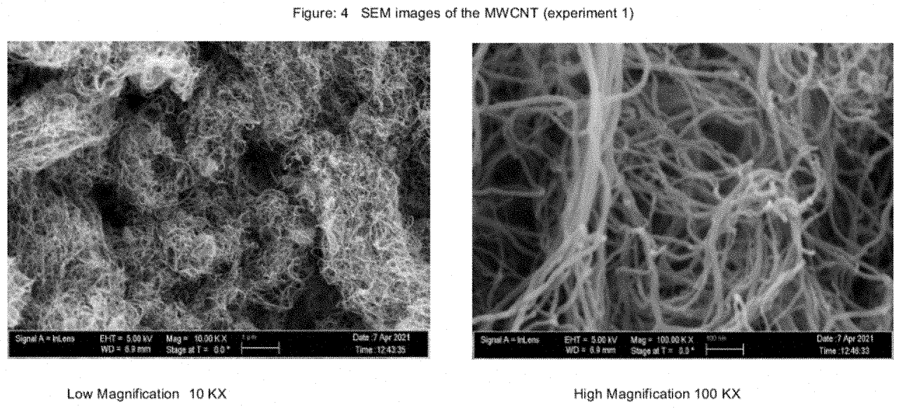

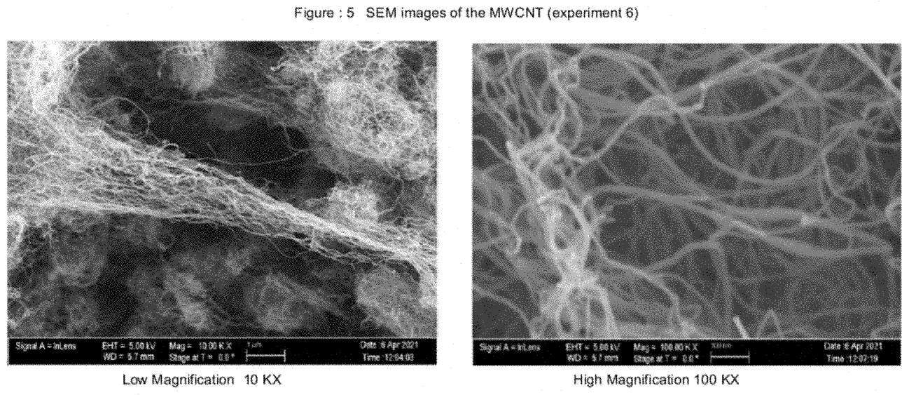

The diameter and length of the carbon nanotubes were measured through the Scanning Electron Microscopy (SEM) technique of analysis. FIGS. 4 and 5 show SEM images corresponding to experiments 1 and 6, respectively, which were taken at magnifications of 10 KX and 100 KX. Experiment 6 (FIG. 5) shows long MWCNTs (L≥7 microns), having a smaller diameter (11+/−2 nm) (and thus L/D ratios of over 500) than the CNTs in the prior-art experiment 1 (FIG. 4) (L=2-3 microns, D=14+/−2 nm).

### Example 5: Continuous Production of Multiwalled Carbon Nanotubes and Hydrogen

This example illustrates the production of carbon nanotubes employing the system, reactor and process of the present invention shown in FIG. 1. Table 2 shows the production of CNT and H₂ and the volume of recycled ethylene and H₂ at different catalyst feed rates. The ethylene flow in the reactor inlet is 11 L/min. The catalyst residence time in the rotary tube reactor is 10 minutes. The reaction temperature is 675° C. and the carbon yield is 80% for the different conditions. The composition of H₂ in the feed gas is 20% V. The residence time of the catalyst is controlled through the rotation rate of the rotary tube and the inclination angle. As the catalyst feed rate into the reactor is increased, the consumption of ethylene and the production of hydrogen increases progressively. For a C₂H₄/catalyst contact time of 4.6 L/g catalyst, the higher CNT and hydrogen production are obtained and the percentage of recycled C₂H₄ is approximately 20%.

TABLE 2
CNT and H₂ production and C₂H₄ recycle volume at different C₂H₄/
catalyst contact times.

| C₂H₄ con- | | | C₂H₄ | | |
|---|---|---|---|---|---|
| tact time | Product | Carbon | con- | Un-reacted | H₂ |
| (L/g. | recovery | deposited/ | sumption | C₂H₄ | produced |
| catalyst) | (g) | g catalyst | (L) | (L) | (L) |
| 9.2 | 60 | 4 | 45 | 65 | 90 |
| 6.1 | 90 | 4 | 67 | 43 | 134 |
| 4.6 | 120 | 4 | 90 | 20 | 179 |
| H₂ + C₂H₄ | Fresh | | | H₂ | H₂ for heat |
| flow (re- | C₂H₄ | Recycled | H₂ | compostion | and energy |
| actor exit) | added | C₂H₄ | recycled | reactor inlet | (L/h)/g |
| (L/min) | (L/min) | (%) | (L/min) | (%) | catalyst |
| 15 | 4.5 | 59 | 3 | 20 | 25 |
| 18 | 6.7 | 39 | 3 | 20 | 31 |
| 20 | 9.0 | 19 | 3 | 20 | 35 |

### Example 6: Continuous Production of Single and Double Walled Carbon Nanotubes from Methane

This example illustrates the production SWCNT and double-wall CNT (DWCNT) from catalytic decomposition of methane employing the system and related process of the present invention shown in FIG. 1.

The reaction temperature, methane composition in the reaction gas, and the type of catalyst are important synthesis parameters for the selective production of SWCNT or DWCNT. For SWCNT synthesis the reaction temperature should be below 950° C., preferably in the 800 to 900° C. temperature range. Methane can be diluted using an inert gas, such as nitrogen, or in hydrogen. For the selective production of SWCNT, the methane composition is below 50% V, preferably between 20 and 30% V.

For DWCNT synthesis, the reaction temperature is higher than 900° C., preferably in the 950 and 1000° C. range. Methane composition in the reaction gas varies between 25 to 50% V, preferably between 25 to 40% V.

The type of catalyst used for both SWCNT and DWCNT synthesis consists of a combination of transition metals (typically Fe, Co, Ni, Mo, etc.) supported on metal oxides, such as MgO, Al₂O₃, TiO₂, SiO₂ and mixtures of them. The residence time of the catalyst in the reaction zone for both SWCNT and DWCNT is typically greater than 5 minutes.

A FeMo/MgO catalyst, (2% total metal and Fe/Mo atomic ratio=2) was contacted with a gas mixture CH₄+H₂ (30% CH₄) at a temperature of 975° C. and a residence time in the reactor of 5 minutes. The contact time between the methane gas flow and the catalyst was 1.13 L/g per minute of reaction. Table 3 shows the results obtained in the continuous production of DWCNT. The amount of DWCNT deposited per gram of catalyst, as determined through ash content and thermogravimetric analysis, was 0.25 grams per gram of catalyst fed into the reactor. This corresponds to a carbon yield of 20%. Fresh methane added was 41% and the H₂ produced for the generation of heat, energy and other industrial uses was 11.2 L/h per gram of catalyst. The selectivity to SWCNT and DWCNT from methane composition reaction depends on the type of catalyst employed, CH₄/H₂ composition ratio in the gas feed, and the reaction temperature.

TABLE 3
Production of SWCNT and DWCNT from methane.

| C₂H₄ contact | | | C₂H₄ | | |
|---|---|---|---|---|---|
| time | Product | Carbon | con- | Un-reacted | H₂ |
| (L/g. | recovery | deposited/ | sumption | CH₄ | produced |
| catalyst) | (g) | g catalyst | (L) | (L) | (L) |
| 1.13 | 25 | 0.25 | 9.33 | 13.17 | 18.67 |
| H₂ + CH₄ | | | | H₂ | H₂ for heat |
| flow | Fresh | | | compostion | and energy |
| (reactor | CH₄ | Recycled | H₂ | reactor | (L/h) per |
| exit) | added | CH₄ | recycled | inlet | g of |
| (L/min) | (L/min) | (%) | (L/min) | (%) | catalyst |
| 16.87 | 1.87 | 59% | 10.5 | 70 | 11.2 |

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A reactor system that is configured to produce carbon-containing material by exposure of carbon-containing reaction gas to catalyst particles, the reactor system comprising:
a reactor that contains a heated reaction volume wherein the reaction gas is exposed to the catalyst particles;
at least one reaction gas entry port that is configured to introduce the reaction gas into the reaction volume; and
at least one catalyst particle entry that is configured to introduce the catalyst particles into the reaction volume;
wherein the catalyst particles are heated before they contact the reaction gas in the reaction volume.

2. The reactor system of claim 1, wherein the carbon-containing material comprises at least one of carbon nanotube-containing material, carbon nanotube-hybrid material, and carbon nanotubes.

3. The reactor system of claim 2, wherein the carbon nanotube-hybrid material comprises at least one of carbon nanotubes-carbon black, carbon nanotubes-graphite, carbon nanotubes-graphene nano-platelets, carbon nanotubes-silicon, carbon nanotubes-alumina, carbon nanotubes-magnesium oxide, carbon nanotubes-silica, carbon nanotubes-activated carbon, carbon nanotubes-cementitious material, carbon nanotubes-SiOₓ, and carbon nanotubes-carbon fiber materials.

4. The reactor system of claim 1, wherein the catalyst particle entry comprises a duct that passes from outside the reactor into the reaction volume, the reactor comprises a rotary tube reactor, the reaction volume is heated to a reaction temperature, and the catalyst particles are heated to approximately the reaction temperature before they contact the reaction gas.

5. The reactor system of claim 1, wherein the reactor comprises an outlet for the carbon-containing material that is produced in the reactor, unreacted reaction gas, and reaction by-products, and further comprising a gas/solid separator that is coupled to the reactor outlet and is configured to separate the carbon-containing material from the unreacted reaction gas and reaction by-products, and a gas/liquid separator that is configured to separate by condensation polymerized carbon compounds produced by thermal decomposition of the carbon source from the unreacted reaction gas and reaction by-products.

6. The reactor system of claim 5, further comprising a gas recycling system that is configured to return at least some of the unreacted reaction gas to the reactor, wherein the gas recycling system comprises a gas separator that is configured to separate unreacted reaction gas from reaction by-products.

7. The reactor system of claim 6, wherein the reaction by-products comprise hydrogen.

8. The reactor system of claim 5, further comprising a product vessel that is configured to hold carbon-containing material separated by the gas/solid separator, wherein the product vessel is flushed with inert gas.

9. The reactor system of claim 1, wherein the catalyst particle entry comprises a catalyst feed tube that passes from outside the reactor into the reaction volume, and wherein the catalyst feed tube extends along from about ⅙ to about ⅓ of a length of the reactor.

10. The reactor system of claim 9, wherein the reactor has a reaction volume diameter, and the catalyst feed tube has a diameter of about ⅓ to about ½ the diameter of the reaction volume.

11. The reactor system of claim 9, further comprising a catalyst feed system that is configured to feed catalyst into the feed tube and out of the feed tube into the reactor, wherein the catalyst feed system comprises a vibratory feeder that is configured to move catalyst along and out of the feed tube at a controllable rate.

12. The reactor system of claim 11, wherein the catalyst feed system further comprises a catalyst holding vessel that is flushed with inert gas and is configured to supply catalyst to the vibratory feeder, a screw feeder that is configured to supply catalyst to the holding vessel at a controllable rate, and a screw feeder supply vessel that is flushed with inert gas and is configured to supply catalyst to the screw feeder.

13. The reactor system of claim 1, wherein the temperature in the reaction volume is measured through a thermowell.

14. The reactor system of claim 1, wherein the reaction volume and the catalyst are heated to at least 650° C., and wherein a residence time of catalyst in the reactor is at least about 6 minutes.

15. The reactor system of claim 1, wherein hydrogen composition in the reaction gas is up to about 30%.

16. The reactor system of claim 1, wherein the carbon-containing material comprises carbon nanotubes (CNT).

17. The reactor system of claim 16, wherein the CNT have a length of at least about 7 microns.

18. The reactor system of claim 16, wherein the CNT have a length to diameter ratio of at least about 500.

19. The reactor system of claim 1, wherein the reaction volume and the catalyst are both heated to at least 700° C. before being contacted, and wherein the reaction gas comprises ethylene.

20. The reactor system of claim 1, wherein the reaction volume and the catalyst are both heated to at least 950° C. before being contacted, and wherein the reaction gas comprises methane.

21. A method of producing carbon-containing material by exposure of carbon-containing reaction gas to catalyst particles in a reactor system that comprises a reactor that contains a heated reaction volume that is heated to a reaction temperature and wherein the reaction gas is exposed to the catalyst particles, at least one reaction gas entry port that is configured to introduce the reaction gas into the reaction volume, and at least one catalyst particle entry that is configured to introduce the catalyst particles into the reaction volume, the method comprising:
heating the catalyst particles to approximately the reaction temperature before they contact the reaction gas in the reaction volume.
